(19) United States
(12) Patent Application Publication
(10) Pub. No.: US 2013/0032124 A1
(43) Pub. Date: Feb. 7, 2013

(54) FUEL CIRCULATION SYSTEM FOR DIMETHYL-ETHER FUEL VEHICLE

(71) Applicant: Jongmin JANG, Hwaseong-si (KR)

(72) Inventor: Jongmin JANG, Hwaseong-si (KR)

(73) Assignee: Hyundai Motor Company, Seoul (KR)

(21) Appl. No.: 13/289,941

(22) Filed: Nov. 4, 2011

(30) Foreign Application Priority Data
Aug. 1, 2011 (KR) 10-2011-0076700

(51) Int. Cl. F02M 69/46

(52) U.S. Cl. 123/456

(57) ABSTRACT

A fuel circulation system for a dimethyl-ether fuel vehicle may include a fuel tank storing a fuel, a fuel supply line connected to the fuel tank, a fuel supply pump disposed in the fuel supply line and supplying the fuel to a fuel injection system under pressure, a common rail maintaining the pressure of the fuel pressurized from the fuel supply pump, the fuel injection system injecting the fuel supplied from the common rail, a fuel return line fluid-communicating with and diverging from the fuel injection system and/or the common rail to collect remaining fuel of the fuel, and a fuel cooling system disposed on the fuel return line such that a return fuel returned from the fuel injection system and/or the common rail passes therethrough, wherein the fuel cooling system may be disposed close to a heater core to exchange a heat of the return fuel.

### CROSS-REFERENCE TO RELATED APPLICATIONS

The present application claims priority to Korean Patent Application Number 10-2011-0076700 filed Aug. 1, 2011, the entire contents of which application is incorporated herein for all purposes by this reference.

### BACKGROUND OF THE INVENTION

1. Field of the Invention

The present invention relates to a heating system, and more particularly, to a heating system of a dimethyl-ether (DME) fuel vehicle that can optimize heating performance of a DME fuel vehicle, in which the DME has been developed as a substitute energy.

2. Description of Related Art

In general, a diesel engine used in vehicles has an advantage of having high thermal efficiency and discharging a small amount of carbon dioxide that is a gas causing global warming in comparison to other engines, but has a problem in that it discharges a large amount of particle materials (PM) and nitride oxides (NOx).

Accordingly, although using a natural gas and LPG, as a low-air pollution substitute fuel for the diesel engine, has been actively promoted, there is a problem in that thermal efficiency decreases in comparison to the diesel engine and it is required to reconstruct many parts, including the fuel system, such that dimethyl-ether (hereafter, referred to as ‘DME’) has been considerably spotlighted as a substitute fuel for the diesel engine.

The DME has a centane number higher than diesel fuel at a melting point of 138.5 degrees and a boiling point of 25.1 degrees (1 atmospheric pressure) and does not generate soot even when burning, such that it rises as clean energy that less contaminate the environment and has been used for an LPG infra and a diesel engine.

Since the DME has a property of changing into a gas under a room temperature and the atmospheric pressure, the DME is pressurized to be liquefied to use DME as fuel and supplied to an engine.

The DME is for preventing bubbles from being mixed into the DME by evaporation, unstable revolution of the engine, and generation of cavitation in a pipe or a pump.

Meanwhile, when excessive pressure is applied to the DME, viscosity of the DME decreases and the DME leaks, such that a collecting system for adjusting temperature and pressure is required. Therefore, it is very important to maintain the liquefied state by appropriately cooling and pressurizing the DME.

For these reasons, the fuel temperature is cooled to be stable by collecting the DME fuel in a fuel system of an engine where the DME fuel is used.

The temperature of return fuel of the DME fuel is high at 100 degrees or more, such that a specific cooling device is disposed to cool it. However, it is required to keep operating a power generator and energy is wasted in order to operate the specific cooling device, which decreases fuel efficiency.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to reduce the number of times of operating a driving power generator for operating a fuel cooler.

Further, various aspects of the present invention are directed to improve heating performance for winter by recirculating collected heat of return fuel at 100□ or more of a DME fuel device into a heater core.

A fuel circulation system for a dimethyl-ether fuel vehicle may include a fuel tank storing a fuel, a fuel supply line connected to the fuel tank, a fuel supply pump disposed in the fuel supply line and supplying the fuel to a fuel injection system under pressure, a common rail maintaining the pressure of the fuel pressurized from the fuel supply pump, the fuel injection system injecting the fuel supplied from the common rail, a fuel return line fluid-communicating with and diverging from the fuel injection system and/or the common rail to collect remaining fuel of the fuel, and a fuel cooling system disposed on the fuel return line such that a return fuel returned from the fuel injection system and/or the common rail passes therethrough, wherein the fuel cooling system may be disposed close to a heater core to exchange a heat of the return fuel.

The fuel may be dimethyl-ether.

The fuel cooling system may include a heat exchanger disposed around the fuel return line and an electric cooling fan.

The heat of the return fuel may be exchanged between the heat exchanger and the heater core by the electric cooling fan.

The fuel supply pump may include a low-pressure pump disposed in the fuel supply line after the fuel tank and pressurizing the fuel in the fuel tank at a predetermined pressure, and a high-pressure pump disposed at a downstream side of the low-pressure pump and pressurizing the fuel at higher pressure than the predetermined pressure implemented by the low-pressure pump.

The fuel circulation system for the dimethyl-ether fuel vehicle may further include an accumulator disposed on the fuel return line and preventing pulsation in the fuel return line after cooling the return fuel in the fuel cooling system.

The fuel circulation system for the dimethyl-ether fuel vehicle may further include a regulator disposed in the fuel return line to fluid-communicate with the fuel tank and controlling the return fuel at a predetermined pressure.

The fuel circulation system for the dimethyl-ether fuel vehicle may further include a check valve disposed in the fuel return line and preventing backflow between the regulator and the fuel tank.

According to the exemplary embodiments of the present invention, since it is possible to remove a specific electric heating body for supplying high-temperature air in winter or in an earlier start state, the manufacturing cost is reduced.

Further, it is possible to achieve both improvement of heater performance and fuel cooling effect by collecting the return fuel.

In addition, it is possible to improve the fuel efficiency by decreasing the number of times of operating the driving power generator for operating the fuel cooler.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view schematically showing the entire configuration of a fuel circulation system for dimethyl-ether fuel vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention are described hereafter in detail with reference to the accompanying drawings.

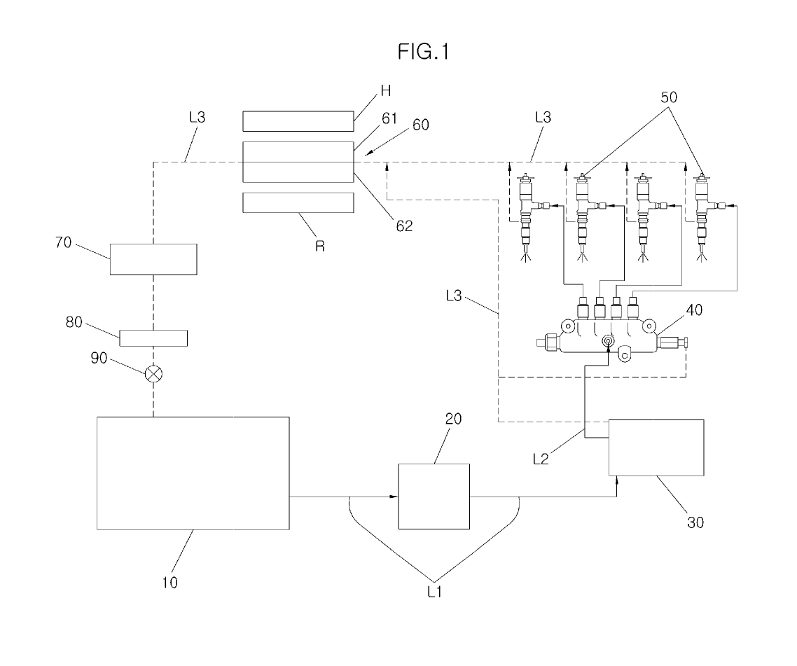

Referring to FIG. 1, the fuel circulation system for dimethyl-ether fuel vehicle according to the exemplary embodiment of the present invention includes a fuel tank 10, a low-pressure pump 20, a high-pressure pump 30, a common rail 40, a fuel injection system 50, a fuel cooling system 60, an accumulator 70, and a regulator 80.

Fuel tank 10 has a function of storing liquid-state DEM fuel. Low-pressure pump 20 that discharges the stored fuel may be disposed in fuel tank 10. In this configuration, although acupressure may be sufficient to supply liquid-state DME fuel, it is preferable to use two specific fuel pumps because the DME fuel may evaporate due to an increase in temperature in high-pressure pump 30.

That is, the DME fuel is sent under pressure by low-pressure pump 20 for primarily discharging the fuel from fuel tank 10 through a low-pressure supply line L1 that communicates with fuel tank 10. The DME fuel is supplied to high-pressure pump 30 after increasing in pressure to about 20 bar through low-pressure pump 20.

The DME fuel passing through low-pressure pump 20 makes fuel pressure of about 900 bar via a high-pressure supply line L2 through high-pressure pump 30.

Thereafter, the DME fuel at high pressure, as described above, is filled at high pressure in a common rail 40 disposed to maintain the pressure while passing through high-pressure supply line L2 and a plurality of fuel injection systems 50 are connected to common rail 40 through distribution channels, such that the fuel injected into a combustion chamber of an engine is compressed and exploded with air.

The fuel at the rear end of high-pressure pump 30 or remaining in common rail 40 and the returned fuel collected after being injected into the combustion chamber from fuel injection systems 50 return to fuel tank 10 through a fuel return line L3. In this configuration, fuel cooling system 60 for sending the fuel increasing in temperature to fuel tank 10 under a stable and liquid state is disposed in fuel return line L3.

Fuel cooling system 60 includes a heat exchanger 61 and an electric cooling fan 62 that are disposed between a heater core H and a radiator R.

In this configuration, heat exchanger 61 exchanges heat with a heater core H, which is described below, by operation of electric cooling fan 62 and heater core H is disposed close to fuel cooling system 60.

That is, when warming-up of the engine is completed, high-temperature air passing through fuel cooling system 60 is discharged outside or cooled by a radiator R by the operation of electric cooling fan 62, and when the driver operates the heater, heater core H is heated by high-temperature return fuel through fuel cooling system 60, such that the temperature in the interior air increases. As described above, as the heat energy of the return fuel of the DME is transferred to heater core H, it is possible to reduce the number of times of operating a driving power generator, such as electric cooling fan 62, which operates to cool the return fuel.

As described above, it is possible to more efficiently cool the heating system by not discharging the heat energy of the returned fuel to the outside, but using it for heating.

According to the configuration, when the vehicle is started or the temperature of the external air is low, and when the engine is not sufficiently warmed up, it is possible to quickly supply high-temperature air to heater core H by using the heat transferred from the return fuel, even if heater core H fails to appropriately perform a heating function.

Accumulator 70 may be disposed to prevent pulsation in fuel return line L3 after the fuel cooled by fuel cooling system 60 is cooled in the liquid fuel state.

Regulator 80 is disposed to communicate with accumulator 70 and fuel tank 10 and maintains the return fuel at a predetermined pressure.

Thereafter, a check valve 90 that is generally used to prevent backflow from fuel tank 10 may be further disposed between regulator 80 and fuel tank 10.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel circulation system for a dimethyl-ether fuel vehicle, comprising:
a fuel tank storing a fuel;
a fuel supply line connected to the fuel tank;
a fuel supply pump disposed in the fuel supply line and supplying the fuel to a fuel injection system under pressure;
a common rail maintaining the pressure of the fuel pressurized from the fuel supply pump;
the fuel injection system injecting the fuel supplied from the common rail;
a fuel return line fluid-communicating with and diverging from the fuel injection system and/or the common rail to collect remaining fuel of the fuel; and
a fuel cooling system disposed on the fuel return line such that a return fuel returned from the fuel injection system and/or the common rail passes therethrough, wherein the fuel cooling system is disposed close to a heater core to exchange a heat of the return fuel.

2. The fuel circulation system for the dimethyl-ether fuel vehicle as defined in claim 1, wherein the fuel is dimethyl-ether.

3. The fuel circulation system for the dimethyl-ether fuel vehicle as defined in claim 1, wherein the fuel cooling system includes a heat exchanger disposed around the fuel return line and an electric cooling fan.

4. The fuel circulation system for the dimethyl-ether fuel vehicle as defined in claim 3, wherein the heat of the return fuel is exchanged between the heat exchanger and the heater core by the electric cooling fan.

5. The fuel circulation system for the dimethyl-ether fuel vehicle as defined in claim 1, wherein the fuel supply pump includes:
a low-pressure pump disposed in the fuel supply line after the fuel tank and pressurizing the fuel in the fuel tank at a predetermined pressure; and
a high-pressure pump disposed at a downstream side of the low-pressure pump and pressurizing the fuel at higher pressure than the predetermined pressure implemented by the low-pressure pump.

6. The fuel circulation system for the dimethyl-ether fuel vehicle as defined in claim 1, further comprising an accumulator disposed on the fuel return line and preventing pulsation in the fuel return line after cooling the return fuel in the fuel cooling system.

7. The fuel circulation system for the dimethyl-ether fuel vehicle as defined in claim 1, further comprising a regulator disposed in the fuel return line to fluid-communicate with the fuel tank and controlling the return fuel at a predetermined pressure.

8. The fuel circulation system for the dimethyl-ether fuel vehicle as defined in claim 7, further comprising a check valve disposed in the fuel return line and preventing backflow between the regulator and the fuel tank.
